(19) United States
(12) Patent Application Publication
(10) Pub. No.: US 2010/0104715 A1
(43) Pub. Date: Apr. 29, 2010

(54) FLAVOR DELIVERY SYSTEM FOR A BEVERAGE CONTAINER

(75) Inventors: Joseph T. Norris, Cumming, GA (US); Mark Payne, Woodstock, NY (US); Jared Richardson, New York, NY (US); Jonathan Crawford-Phillips, Brooklyn, NY (US); Rony Zibara, New York, NY (US)

Correspondence Address: THE COCA-COLA COMPANY;PATENT & TECHNOLOGY DEPT--NAT 19, P. O. BOX 1734, ATLANTA, GA, 30301, US

(73) Assignee: The Coca-Cola Company, Atlanta, GA (US)

(21) Appl. No.: 12/576,469

(22) Filed: Oct. 9, 2009

Related U.S. Application Data
(60) Provisional application No. 61/108,842, filed on Oct. 27, 2008.

(51) Int. Cl. B65D 81/32; A47J 31/00

(52) U.S. Cl. 426/394; 99/323; 426/397

(57) ABSTRACT

The invention is a beverage container that provides a flavor delivery system capable of delivering a burst of flavor when a drinker places her mouth to portions of the beverage container. The flavor delivery system can provide visual and fragrance cues to indicate the type of flavor to be expected from a flavored beverage resident within the beverage container or from flavor components included within the flavor delivery system.

### FIELD OF THE INVENTION

The invention relates to a beverage container that provides a burst of flavor when a user takes a drink. More specifically, the container contains a flavor delivery system that delivers one or more pre-configured flavors to a drinker that consumes a beverage from a beverage container equipped with a flavor delivery system.

### BACKGROUND OF THE INVENTION

Many have tried to flavor beverages with secondary components like powders, syrups, crystals, etc. which may be added directly to a beverage in a container to add, change or enhance its flavor constituents. Persons of skill in the art have even sought to alter a beverage container to provide a perception of flavor based upon the intentional presence of fragrance notes built into a bottle's cap.

U.S. Pat. No. 6,045,833 (Landau '833) provides a beverage container that is scented with a fragrance. Landau '833 notes that a person who consumes a product directly from its container will bring the container's lid to his mouth. As the container's lid is taken within the mouth, the lid releases a fragrance to the air within the drinker's mouth. At the same time, the portion of the container's lid outside of the mouth fragrances the air surrounding the outside of the nose. By scenting the air inside the mouth and outside the nose, the nose is saturated by the desired fragrance and a more effective olfactory sense deception is obtained. Actual taste is not achieved, however, but the affect on the perception of taste that fragrance is well-known in the art to provide occurs.

What is needed therefore is a beverage container that can provide an actual flavor or taste at contact of the beverage with a drinker's mouth. Such flavor would be intended to enhance the flavor of already flavored beverages or add flavor to either low or no flavored beverages like water.

### BRIEF DESCRIPTION OF THE INVENTION

Accordingly, the invention provides a beverage container that delivers flavor comprising a container having a body, a stem having a length connected to the body and a mouth portion connected to the stem. The mouth portion has a rimmed opening from which beverage exits the beverage container during drinking. The beverage container has an external surface and an internal surface positioned oppositely to the external surface. A cap may be detachably attached to the mouth portion of the beverage bottle and may contain at least a portion of a flavor delivery system.

On the beverage container, and integrated with the container, exist one or more flavor zones positioned, preferably, about the rimmed opening of the container's mouth portion. Alternatively, a flavor zone is positioned about the stem of the container's mouth portion. Also alternatively, the flavor zone is positioned about the rimmed opening and the stem of the container's mouth portion. Optionally, the stem of a container herein may be threaded with alternating raised and depressed portions. When a flavor delivery system herein is positioned onto such a threaded stem, flavor components of the flavor delivery system may be positioned on the raised portions, the depressed portions or both.

Flavor components of the flavor delivery system may be activated in one or more of several ways. For example, flavor components resident within a flavor zone are preferably activated at contact with a drinker's mouth. That is, when a drinker's mouth comes into direct contact with a flavor zone positioned about the stem or opening of a container herein moisture from a drinker's mouth makes contact with flavor components therein, moistening them and causing their transfer from the flavor zone to a drinker's mouth.

In an alternative embodiment herein flavor components resident within the flavor zone may activate at detachment of the container's cap from the container. Such flavor activation would occur prior to a consumer's mouth touching a flavor zone on a container herein. The activation occurs as a result of friction between the internal cap surface and stem surface. When the container's stem is threaded and the container's cap is also threaded to match the stem, flavor components positioned about the stem, and especially on the threads of the stem, are activated due to the frictional interaction that occurs at removal of a cap from the container's stem.

The flavor delivery system may also provide a visual cue to the presence of the flavor delivery system. The visual cue may be a physical part of the flavor delivery system itself. In practice, as the flavor components of the flavor delivery system are depleted the visual cue, which first confirms the existence of the flavor delivery system, can now show the depletion of flavor components thus also providing a signal of the loss of flavor with use. Alternatively, such a visual cue will be configured to only show the existence of the flavor delivery system but not show its loss at any point during use thereof.

In addition to providing flavor components, the flavor delivery system may also provide one or more fragrances. The fragrances used herein may be used to provide a perception of flavor to a beverage contained within the beverage container. A preferred embodiment herein, therefore, is a beverage container that contains an orange flavored beverage, a flavor delivery system that provides orange flavor components and orange fragrance, the orange flavor components and orange fragrance operating to enhance the taste experience of the resident orange beverage.

Another embodiment of the invention herein provides a method of delivering a non-beverage flavor component from a beverage container to a user. The method comprises the following steps:
a. Providing a container with a beverage positioned within the container, the container having a body, a stem with a length connected to the body and a mouth portion connected to the stem, the mouth portion having a rimmed opening, the beverage container having an external surface and an internal surface positioned oppositely to the external surface;
b. Positioning a flavor delivery system onto the beverage container, the flavor delivery system having at least one zone of flavor with flavor components positioned therein; and
c. Transferring the flavor components from the zone of flavor to a user's mouth when the user's mouth comes into contact with the beverage container by drinking.

### BRIEF DESCRIPTION OF THE DRAWINGS

While the specification concludes with claims particularly pointing out and distinctly claiming the invention, it is believed that the embodiments set forth herein will be better understood from the following description in conjunction with the accompanying figures, in which like reference numerals identify like elements and in which:

FIG. 1 is a perspective view of a preferred beverage container herein;

FIG. 2 is a partial perspective view of a beverage container's upper portion;

FIG. 3 is an alternative embodiment of FIG. 2;

FIG. 4 is an alternative embodiment of FIG. 2;

FIG. 5 is an alternative embodiment of FIG. 2; and

FIG. 6 is a partial perspective view of a beverage container providing a visual cue.

### DETAILED DESCRIPTION OF THE INVENTION

By the term “beverage container” it is meant herein a container suitable for carrying a food grade beverage whereby the beverage container may be directly or indirectly used for the consumption of a beverage provided within the beverage container. The beverage container may be disposable or non-disposable. Examples of suitable beverage containers herein are pre-formed soda bottles, juice bottles, water bottles sold with beverages therein, re-usable, non-disposable cylindrical bottles, and the like—the foregoing list is not exhaustive.

By the term “disposable” it is meant herein that a beverage container is intended by the manufacturer to provide a single use; e.g., a purchased soda beverage from a soda machine.

By the term “non-disposable” it is meant herein a beverage container that is intended to be used and re-used multiple times after a beverage contained therein has been substantially or fully consumed and that may be replenished with the same beverage or replaced with a different beverage for another use.

By the term “beverage” it is meant herein all manner of food grade beverages suitable for consumption by humans. Examples of such beverages include but do are not limited water, juice, juice-containing beverages, soda, vegetable cocktails, alcoholic beverages, and many others.

By the term “flavor” it is meant herein a distinctive taste of something as it is experienced in the mouth from a substance or extract that provides a particular taste.

Accordingly, the invention provides a beverage container that delivers flavor comprising a container having a body, a stem having a length connected to the body and a mouth portion connected to the stem. The mouth portion has a rimmed opening from which beverage exits the beverage container during drinking. The beverage container has an external surface and an internal surface positioned oppositely to the external surface. A cap may be detachably attached to the mouth portion of the beverage bottle and may contain at least a portion of a flavor delivery system.

On the beverage container, and integrated with the container, exist one or more flavor zones positioned, preferably, about the rimmed opening of the container's mouth portion. Alternatively, a flavor zone is positioned about the stem of the container's mouth portion. Also alternatively, the flavor zone is positioned about the rimmed opening and the stem of the container's mouth portion. Optionally, the stem of a container herein may be threaded with alternating raised and depressed portions. When a flavor delivery system herein is positioned onto such a threaded stem, flavor components of the flavor delivery system may be positioned on the raised portions, the depressed portions or both.

Flavor components of the flavor delivery system may be activated in one or more of several ways. For example, flavor components resident within a flavor zone are preferably activated at contact with a drinker's mouth. That is, when a drinker's mouth comes into direct contact with a flavor zone positioned about the stem or opening of a container herein moisture from a drinker's mouth makes contact with flavor components therein, moistening them and causing their transfer from the flavor zone to a drinker's mouth.

In an alternative embodiment herein flavor components resident within the flavor zone may activate at detachment of the container's cap from the container. Such flavor activation would occur prior to a consumer's mouth touching a flavor zone on a container herein. The activation occurs as a result of friction between the internal cap surface and stem surface. When the container's stem is threaded and the container's cap is also threaded to match the stem, flavor components positioned about the stem, and especially on the threads of the stem, are activated due to the frictional interaction that occurs at removal of a cap from the container's stem.

The flavor delivery system may also provide a visual cue to the presence of the flavor delivery system. The visual cue may be a physical part of the flavor delivery system itself. In practice, as the flavor components of the flavor delivery system are depleted the visual cue, which first confirms the existence of the flavor delivery system, can now show the depletion of flavor components thus also providing a signal of the loss of flavor with use. Alternatively, such a visual cue will be configured to only show the existence of the flavor delivery system but not show its loss at any point during use thereof.

In addition to providing flavor components, the flavor delivery system may also provide one or more fragrances. The fragrances used herein may be used to provide a perception of flavor to a beverage contained within the beverage container. A preferred embodiment herein, therefore, is a beverage container that contains an orange flavored beverage, a flavor delivery system that provides orange flavor components and orange fragrance, the orange flavor components and orange fragrance operating to enhance the taste experience of the resident orange beverage.

Another embodiment of the invention herein provides a method of delivering a non-beverage flavor component from a beverage container to a user. The method comprises the following steps:
a. Providing a container with a beverage positioned within the container, the container having a body, a stem with a length connected to the body and a mouth portion connected to the stem, the mouth portion having a rimmed opening, the beverage container having an external surface and an internal surface positioned oppositely to the external surface;
b. Positioning a flavor delivery system onto the beverage container, the flavor delivery system having at least one zone of flavor with flavor components positioned therein; and
c. Transferring the flavor components from the zone of flavor to a user's mouth when the user's mouth comes into contact with the beverage container by drinking.

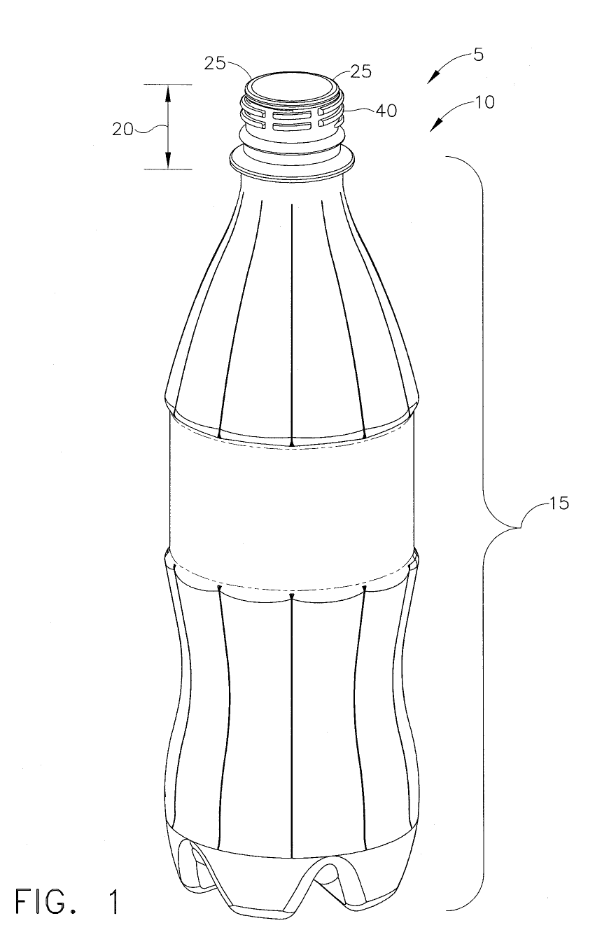

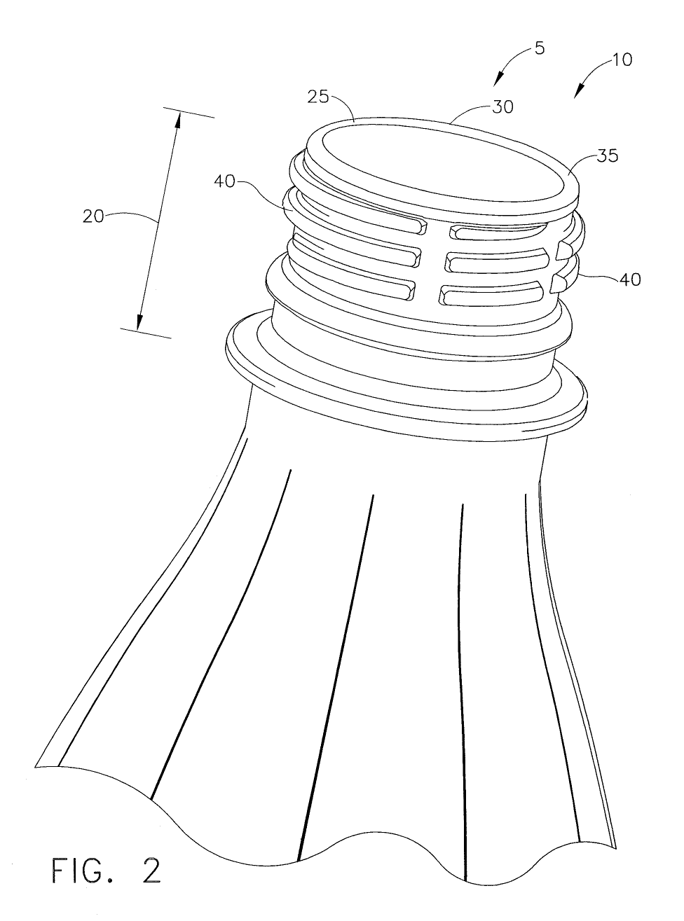

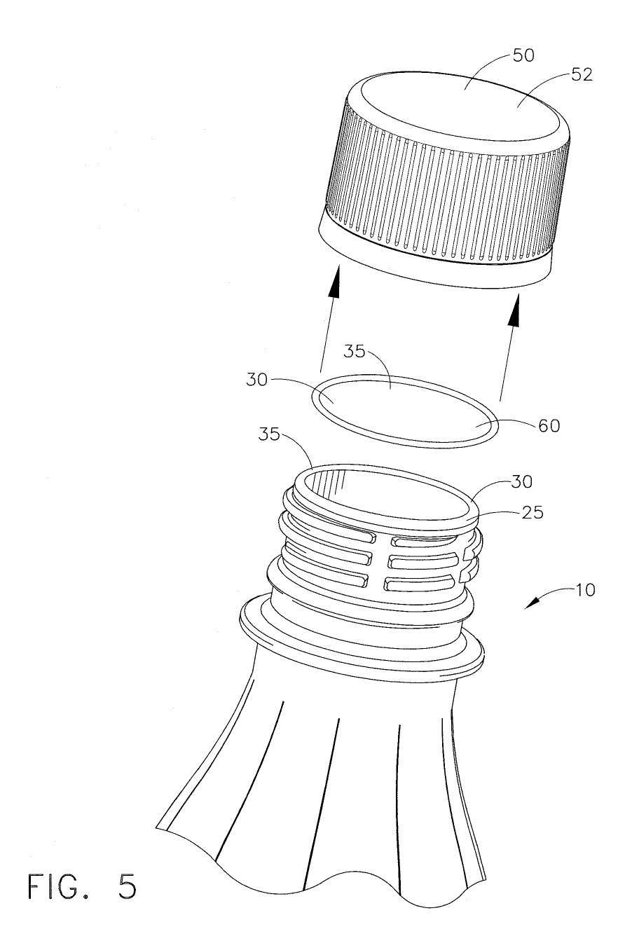

FIG. 1 herein provides a three dimensional view of a beverage container 5 herein. Beverage container 5 is preferably a disposable soda bottle 10 or bottle 10. A preferred bottle comprises a body 15, a stem 20 and a rimmed opening 25. On bottle 10, rimmed opening 25 preferably provides a flavory delivery system for delivery of a taste or flavor to a drinker of a beverage positioned within bottle 10. Also preferably, stem 20 of bottle 10 is threaded (i.e., has threads) suited to receive and be enclosed by a cap (FIG. 5) which has an internal threaded surface (not shown) that operates with threads 40 (FIG. 2) to produce a sealed or substantially sealed enclosure.

FIG. 2 provides a partial perspective view of a bottle 10 herein with flavor delivery system 30 positioned about rimmed opening 25. Flavor delivery system 30 is made up of one or more flavor components 35 shown resident on rimmed opening 25. At contact with a drinker's lips, flavor components 35 are activated by moisture on the lips whereby flavor components 35 dissolve or at least partially dissolve to form a solution. The solution, by the operation of a drinker's mouth, is moved from a drinker's lips to her tongue and palette. At such presence of the solution on an unimpaired drinker's palette, the tongue thereof will sense and register flavor and taste from flavor delivery system 30.

Such delivery of flavor to a drinker, in addition to any flavored beverage resident within bottle 10, is a key benefit. This is especially true in instances in which a beverage has low or no flavor. For low flavored beverages, the addition of flavor delivery system 30 to a low flavored beverage can be extremely helpful for the enjoyment and enhancement of such a beverage. For beverages having no perceptible flavor, like some waters, flavor delivery system 30 can provide a more enjoyable drinking experience without the addition of flavor or sweeteners to the water itself.

An alternative embodiment herein provides for a medicinal delivery system configured similarly to flavor delivery system 30 but that instead delivers medicine and/or vitamins like vitamin C, B12, etc. to a drinker. Such medicinal or vitamin delivery may be included within flavor delivery system 30.

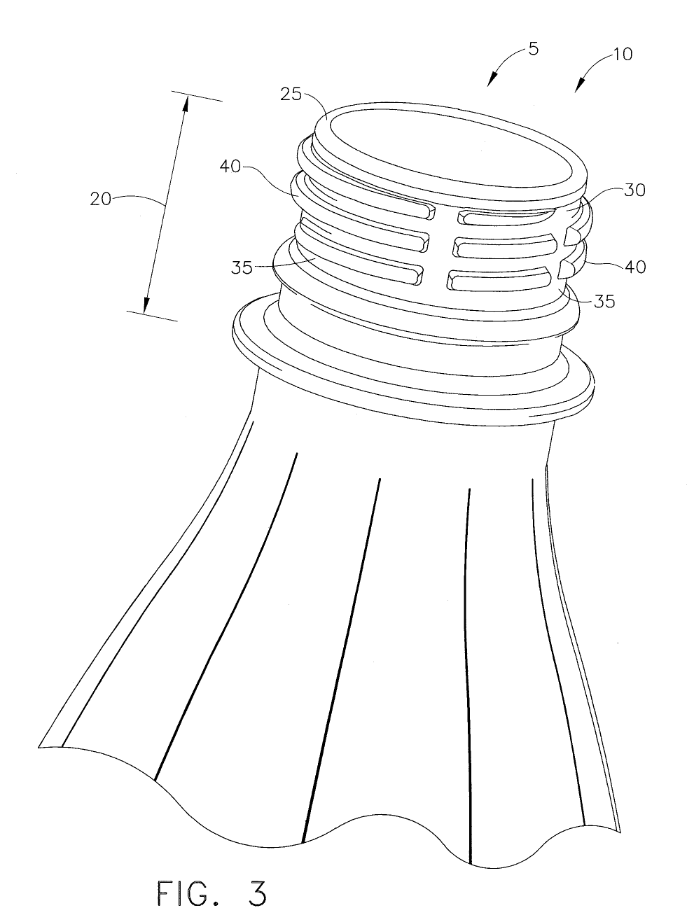

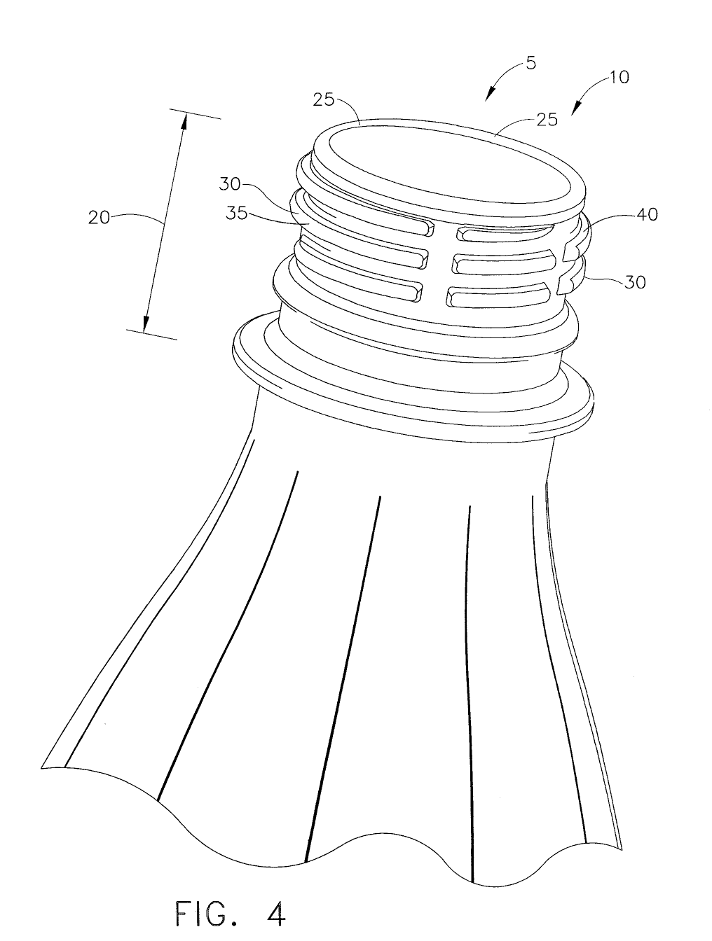

Importantly, FIGS. 3 and 4 show the placement of flavor delivery system 30 positioned within threads 40 and also onto threads 40, respectively. This is an appropriate positioning of flavor delivery system 30 given that a drinker's mouth, in addition to touching rimmed opening 25, will also tend to contact threaded portions of stem 20. Though not shown it should be readily recognized by persons of skill in the art that flavor delivery system 30 may be positioned about all shown parts of stem 20 herein; namely, rimmed opening 25, threads 40 and the portions of stem 20 that are positioned between threads 40.

Another important embodiment of the invention herein is shown in FIG. 5. As shown, cap 50 and seal 60 is provided. Seal 60 is shown to be separate and distinct from cap 50 but actually resides on the internal surface of the back wall 52 of cap 50—i.e., underneath cap 50. Seal 60 may be used as part of flavor delivery system 30. When cap 50 is fitted in a closed position onto bottle 10, at least a portion of seal 60 is held to be in contact with rimmed opening 25. Seal 60 contains flavor components 35 that may transfer from seal 60 to rimmed opening 25 upon contact. Also, flavor components 35 may transfer from seal 60 to rimmed opening 25 at removal of cap 50 from bottle 10 through friction. As surfaces of seal 60 and rimmed opening 25 contact and move past one-another during removal of cap 50, flavor components 35 are dislodged from seal 60 and thereby transfer to rimmed opening 25.

The ability to transfer flavor components 35 from seal 60 to rimmed opening 25 is an important feature. It is especially important when it is desired to be able to re-charge rimmed opening 25 with flavor components 35 over the duration of the drinking experience. For example, rimmed opening 25 may be re-charged with flavor components 35 from seal 60 each time cap 50 is wholly applied, in a closed position, to stem 20. By the mechanisms of friction and/or contact as discussed above, such re-charge of rimmed opening 25 occurs. When a drinker drinks a beverage housed in bottle 10, removing and re-applying cap 50 to bottle 10, the drinker experiences re-newed bursts of flavor at contact of the drinker's lips and mouth to stem 20 and especially to rimmed opening 25.

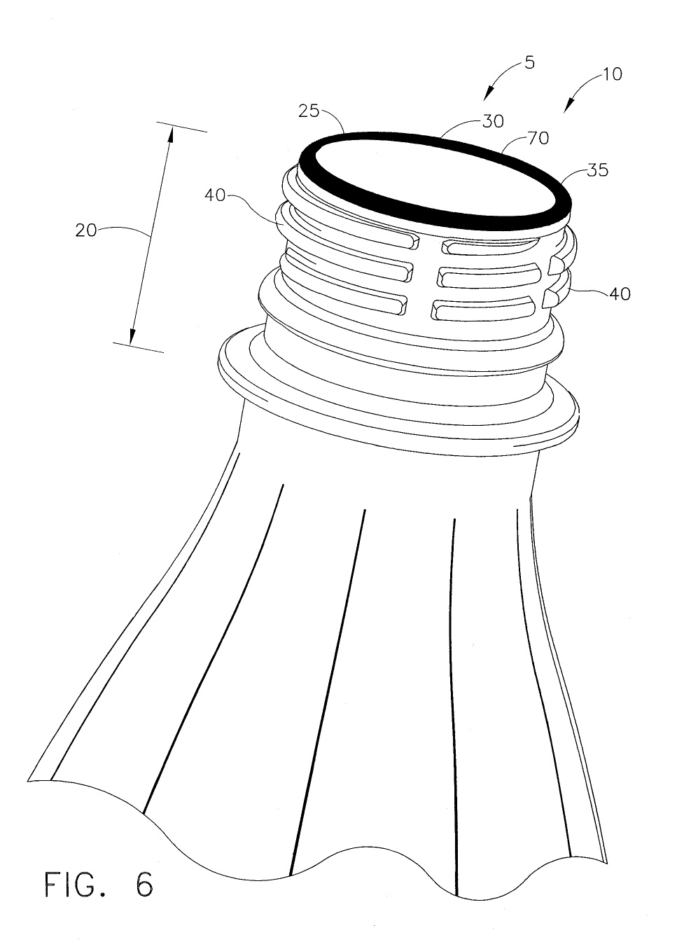

Another embodiment herein provides for a visual cue to be provided as part of flavor delivery system 30. In preferred practice, visual cue 70 (FIG. 6) of flavor delivery system resides as a colored layer on rimmed opening 25. The colored layer indicates to a drinker that flavor components 35 are present and thereby builds an expectation of the delivery of flavor. The colored layer of visual cue 70 may be a color that reflects or signals the expected flavor to be tasted from flavor delivery system 30; e.g., an orange colored layer for orange flavor, a lime green colored layer for lime flavor, a red colored layer for strawberry flavor and so forth. Persons of skill in the art readily recognize that nearly limitless colors and combinations thereof may be used in visual cue 70. Over time, visual cue 70 can be made to diminish as an additional cue of the depletion of flavor components 35 from stem 20. Such cue of diminishment can prompt a drinker to re-charge flavor components 35 on contacted surfaces of stem 20 as noted herein above as part of the re-charge embodiment.

Flavor delivery system 30 can be applied to beverage container 5 in several ways. One way of application provides for a solution to be added portions of stem 20 that will most likely be in contact with a drinker's lips and mouth (i.e., rimmed opening 25, threads 40 and between threads 40). Such solution is then dried by air or cured by heat onto those surfaces for later activation by the moisture of a drinker's lips and mouth. The solution can be dried to create adhesion to the beverage container 5 by hot air, convection methods or infrared heating of stem 20. Application of the solution can occur by submersion of beverage container 5 into a solution and/or by use of a sponge or brush containing solution that is then brought into contact with stem 20, including rimmed opening 25. Additional methods of application of the solution can occur through roller coating or targeted spraying.

The flavor solution is preferably a combination of flavor oils and a carrier solvent that enables flavor to be applied and dried to beverage container 5. The resulting dried solution may be cleared, tinted or otherwise colored to provide visual cue 70.

An additional constituent to flavor delivery system 30 is fragrance. Fragrance may be used as part of flavor delivery system 30 to trigger the expectation of a certain flavor and/or to create the perception of flavor prior to and/or during the taste experience that a drinker has with flavor components 35 and a flavored beverage resident within beverage container 5. The interaction between the smell and taste senses are well known to persons of skill in the art. This interaction is discussed in U.S. Pat. No. 6,045,833 the substance of which is fully incorporated by reference herein.

### Example I

In one example herein, a beverage container has a flavored beverage loaded therein whereby such beverage in the beverage container is sold from a vending machine. The subject beverage contains an orange flavored beverage. The flavor delivery system provides a flavor zone that is positioned about the rimmed opening of the beverage container as described previously herein. The flavor components of the flavor zone provides an additional orange flavor. When a drinker removes the cap from the beverage container and takes a drink by placement of the drinker's lips onto the beverage container, a burst of orange flavor, prior to actual consumption of the beverage, is sensed by the drinker. Alternatively, the presence of fragrance oils may accompany the presence of flavor components whereby such fragrance oils when eliciting one or more fragrances create an expectation of taste, such expectation operating to prepare a drinker's palette for the actual sensation of taste from the flavor components and flavored beverage.

### Example II

In another example herein, flavor zones herein are positioned completely about the stem and on the rimmed opening of the bottle. The resident beverage therein is a low flavored or no flavored beverage like water. The flavor components of the flavor zone provides a cherry flavor. When a drinker removes the cap from the beverage container and takes a drink by placement of the drinker's lips onto the beverage container, and about the rimmed opening and stem, the drinker receives a burst of cherry flavor. This flavor burst for low or no flavored beverages like water enhances the beverage drinking experience and can encourage the drinking of healthy beverages like water when flavor is provided.

It should be apparent that the foregoing relates only to the preferred embodiments of the present invention and that numerous changes and modifications may be made herein without departing from the spirit and scope of the invention as defined by the following claims.

1. A beverage container that delivers flavor, comprising:
a. A container having a body, a stem connected to said body and a mouth portion connected to said stem, said mouth portion having a rimmed opening and a stem with a length connected to said rimmed opening, said beverage container having an external surface and an internal surface positioned oppositely to said external surface;
b. A cap detachably attached to said mouth portion of said beverage container; and
c. A flavor delivery system positioned about said beverage bottle, said flavor delivery system having a zone of flavor, said zone of flavor containing flavor components activatably releasing flavor upon contact with a drinker's mouth.

2. The beverage container of claim 1 wherein said flavor zone is positioned about said rimmed opening of said mouth portion.

3. The beverage container of claim 1 wherein said flavor zone is positioned about said stem of said mouth portion.

4. The beverage container of claim 1 wherein said flavor zone is positioned about said rimmed opening and said stem of said mouth portion.

5. The beverage container of claim 1 wherein said flavor zone is activated at contact with a drinker's mouth.

6. The beverage container of claim 1 wherein said flavor zone is activated at detachment of said cap from said beverage bottle.

7. The beverage container of claim 1 wherein said flavor delivery system provides a visual cue to the presence of said flavor delivery system.

8. The beverage container of claim 1 wherein said flavor delivery system additionally provides a fragrance, said fragrance providing a perception of flavor to a beverage contained within said beverage container.

9. A method of delivering a non-beverage flavor component from a beverage container to a user, comprising:
a. Providing a container with a beverage positioned within said container, said container having a body, a stem connected to said body and a mouth portion connected to said stem, said mouth portion having a rimmed opening and a stem with a length connected to said rimmed opening, said beverage container having an external surface and an internal surface positioned oppositely to said external surface;
b. Positioning a flavor delivery system onto said beverage bottle, said flavor delivery system having a zone of flavor with flavor components; and
c. Transferring said flavor components from said zone of flavor to a drinker's mouth when said drinker's mouth comes into contact with said beverage bottle by drinking.

10. The method of claim 9 wherein said flavor zone is positioned about said rimmed opening of said mouth portion.

11. The method of claim 9 wherein said flavor zone is positioned about said stem of said mouth portion.

12. The method of claim 9 wherein said flavor zone is positioned about said rimmed opening and said stem of said mouth portion.

13. The method of claim 9 wherein said flavor zone is activated at contact with a drinker's mouth.

14. The method of claim 9 wherein said flavor zone is activated at detachment of said cap from said beverage bottle.

15. The method of claim 9 wherein said flavor delivery system provides a visual cue as to the presence of said flavor delivery system.

16. The method of claim 9 wherein said flavor delivery system additionally provides a fragrance, said fragrance providing a perception of flavor to a beverage contained within said beverage container.
